(19) United States
(12) Patent Application Publication
(10) Pub. No.: US 2015/0236507 A1
(43) Pub. Date: Aug. 20, 2015

(54) ELECTRICAL POWER DISTRIBUTION UNIT

(71) Applicant: RICHARD BURANT, HARTLAND, WI (US)

(72) Inventor: RICHARD BURANT, HARTLAND, WI (US)

(21) Appl. No.: 14/621,395

(22) Filed: Feb. 13, 2015

Related U.S. Application Data
(60) Provisional application No. 61/939,753, filed on Feb. 14, 2014.

(51) Int. Cl. H02J 3/00; H02H 9/00; H02J 9/06; H02H 3/10

(52) U.S. Cl. CPC H02J 3/006; H02H 3/105; H02H 9/005; H02J 9/061

(57) ABSTRACT

An electrical power distribution unit is disclosed herein which provides for enhanced distribution and circuit protection featured in a compact, cost-efficient footprint capable of regulating and providing protected power supply simultaneously to different load specifications in a seamless manner.

### CROSS REFERENCES TO RELATED APPLICATIONS

This application claims benefit under 35 U.S.C. §119(e) of U.S. Provisional Application No. 61/939,753 filed on Feb. 14, 2014 entitled “Electrical Power Distribution Unit” the contents of which are entirely incorporated herein by reference, as if fully set forth herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE PRESENT INVENTION

The present invention belongs to the field of electronics and, in that, relates generally to devices for handling and distribution of electrical power. More specifically, the present invention relates, in an isolated unrestrictive embodiment, to the adaptive design, construction and operation of a power distribution unit capable of regulating and providing protected power supply simultaneously to different load specifications in a seamless manner.

### BACKGROUND OF THE PRESENT INVENTION

A telecommunications site typically involves a plurality of equipment and facilities including, without limitation, networking systems, mainframe computers, controllers, servers, wireless equipment, routers and other components, having diverse power specifications. Making available and routing reliable and adequate supply of regulated electrical power is therefore among the critical concerns while critically ensuring seamless, fault-free voice and/or data traffic, since any deviation or power loss would imply loss of connectivity besides possible damage to sensitive equipment and facilities involved. Therefore, it would be highly desirable to have some means of effectively delivering regulated, protected electrical power supply to diverse loads simultaneously that is advantageously characterized in having a small footprint and no legacy issues whatsoever.

Power Distribution Unit (hereinafter referred to as the “PDU”) is typically the electrical interface employed at telecommunications sites for distribution of power supply to various equipment and facilities involved. The concept of these interfaces today encompasses devices ranging from simple and inexpensive rack-mounted “power strips” to larger floor-mounted PDUs with multiple functions including power filtering, load balancing and so on.

Conventionally, PDU(s) is/are installed in a component rack(s) alternatively in different positions to accommodate desired accessibility to different point(s)-of-use or routing of power cords therein. Role of the PDU(s) here is to condition, regulate the input power and ensure an interruption-free supply as per individual load specifications of various modules/electrical loads comprising the telecommunication system. Considering the diverse power requirements of subsystems involved, and further the continuity of critical equipment operations they must provide to result in a highly reliable and useful telecommunications network, a PDU therefore needs to have high cost-performance ratio, stability and reliability to constitute a truly effective solution for power distribution in its given application environment. Localization(s)/customization(s) observed in state-of-art PDUs in an attempt to attain aforesaid functionalities make generic-and-configurable design a redundant principle, thus leading to eventualities including hardware multiplicity/obsolescence issues, inadvertent/erroneous implementation/configurations which unequivocally spell potential hazards for both property as well as person on site. It would therefore be advantageous for a PDU to address these issues for ensuring a safe operational environment at a telecommunications site without mandating unfair demands on resources or costs.

During the lifecycle of a telecommunications site, events such as short circuits, lightning and human contact are naturally bound to occur, which however interfere unfavorably with functioning of PDUs and result in the power output being compromised. For the equipment/facility modules these PDUs feed, such eventualities translate into plausible compromises in the system and/or damage to components involved. Hence, an ideal PDU would be one in which fault-free performance is achieved by enhanced management of electrical power while it is being distributed to multiple feeds under various load conditions and, at the same time, safety mechanisms are built-in for protection and recovery from interferences foreseen at the telecommunications site.

Another encumbrance to design of power distribution systems is that said devices are heavily regulated by legacy specifications in same order as the components they feed. The manufacturability and costs thereof are therefore also of concern while envisaging a truly effective PDU intended for wide-scale application in diverse application environments and power standards. Furthermore, PDUs are traditionally hard-wired into the application environment, which requires expert electricians to address their installation, and shut off the system during installation thus, losing productive time.

The foregoing narration is intended to showcase state-of-art as it exists today and its various shortcomings that preserve the necessity-to-invent for the present inventor. The contents as such are not intended to be exhaustive. Additionally, from a cross-sectional study of the state of art, it is evident that concerns of EMI filtering, serviceability, cooling, temperature and humidity monitoring, intelligent and/or configurable phase/power management also need to be addressed while arriving at an effective PDU.

Prior art, to the extent surveyed, bears scattered references to individually protected power load distribution incorporating a lightning/surge suppression system with logic alarming, ground fault protected convenience outlets, and so on. However, widespread applicability of these technologies has been marred due to presence of their inherent disadvantages and deficiencies including, but not limited to, high cost, large size footprint, an inability to provide individually protected load circuits with varying amperage load rating, hot swappable breakers and lightning/surge suppression modules. Another shortcoming of these technologies is that many themselves need external components to protect the power distribution loads or provide ground fault convenience outlets to operate, thus increasing the overall functional cost and physical footprint of the system.

For example, CA 2341988 A1 discloses an electrical power distribution system includes a main disconnect unit and a surge protector unit. The main disconnect includes an electrical power bus having a three phase power bus and neutral bus. However, this design is based on a three phase electrical circuit design to power industrial equipment such as electric motor controllers in an industrial setting. The system is comprised of a frame and door access secured with a padlock. This system cannot be used in telecommunications cabinet or rack assembly. It has no provision for ground fault customer convenience outlets or hot swappable circuit breakers.

Another reference, U.S. Pat. No. 6,380,862 B1 discloses an electrical distribution panel employing a surge protector, such as a residential load center, houses a plurality of circuit breakers that are adapted for electrically interconnecting power lines with loads. However, this design is intended for use in a residential application. It cannot be rack-mounted into a telecommunications cabinet or rack assembly.

Another reference, U.S. Pat. No. 7,268,998 B2 discloses a ganged outlet power distribution apparatus used to distribute a plurality of electronic devices. The power distribution unit may have one or more outlet gangs with integral components providing a plurality of individual power outlets. However, this device is not without its shortcomings. The power distribution apparatus does not provide a main circuit breaker or sub-breakers. It does not provide lightning/surge suppression. It also void of alarming.

Yet another reference, U.S. Pat. No. 6,826,036 B2 discloses a modular power distribution system for use in computer equipment racks. A control unit is mounted within the rack having a power input connected to a power source and a converter for converting the input power to a power supply for the rack equipment. The control unit includes a housing and power outlets are provided for electrical connection to the control unit and distributing the converted power supply to the equipment. However, this power distribution system does not provide lightning/surge suppression. This is not a device designed to be used in a telecommunications environment. It is specifically designed to support computers and their related power supplies in computer equipment racks.

Yet another reference, U.S. Pat. No. 7,196,900 B2 discloses an adaptable rack mountable power distribution apparatus that is adaptable to be readily mounted within a variety of electronic equipment racks. However, this power distribution apparatus does not provide a main circuit breaker or sub-breakers. It does not provide lightning/surge suppression.

Therefore, the prior art surveyed does not enlist a single PDU that addresses each of the considerations voiced in the foregoing narration. The present inventor, in cognizance of these and further wants, has undertaken focused research for establishment of the present invention which is a PDU that majorly addresses these shortcomings of art, when performed in the manner to be disclosed further in this document.

### OBJECTIVES OF THE PRESENT INVENTION

Principles of the present invention are directed towards attainment of certain objectives, being set forth as follows:

Primary objective of the present invention is to provide for construction and deployment of a PDU capable of providing seamless distribution of electrical power simultaneously to various load specifications typically encountered in the telecommunications industry.

Yet another objective of the present invention is to provide a PDU which is capable of protecting, regulating and distributing power supply amongst multiple feeds having individual load requirements.

Yet another objective of the present invention is to provide a PDU having integral mechanisms for protection of load components from lightning strikes.

Yet another objective of the present invention is to provide a PDU having integral mechanisms for protection of human operators from risk of accidental electrocution.

Yet another objective of the present invention is to provide a PDU having modular construction to allow easy installation, serviceability and replacement of faulty components.

Yet another objective of the present invention is to provide a PDU that allows electric power protection circuit breakers to be effectively changed or updated to accommodate different load specifications without interrupting power or operations of other attached systems or without incurring significant increased cost or inconvenience for users.

Yet another objective of the present invention is to provide a PDU design characterized in having compact dimensions, low costs of materials, assemblage, installation, maintenance and operations.

Yet another objective of the present invention is to provide a PDU design characterized in having high accuracy and precision in regulation of power input irrespective of the source of power being generator, UPS, battery and/or utility power.

Yet another objective of the present invention is to provide a PDU design characterized in having alarm functionality sensing circuit collocated within the housing of the PDU and connected to the main circuit breaker and the lightning/surge suppression unit.

A better understanding of how these and other objectives are achieved will be clear from the detailed description set forth below which relates to certain illustrative embodiments which specifically is indicative of the various ways in which the principles of the present invention may be employed.

### BRIEF SUMMARY OF THE PRESENT INVENTION

In accordance with principles of the present invention, a PDU is proposed herein that allows for up to six different sub-systems to be protected and regulated which characteristically includes one main intelligent breaker and six subordinate breakers for individual load requirements. Monitored lightning-suppression layer and ground fault circuit protection functionality are integrated for protection of components from lightning strikes and/or protection of human subjects from accidental electrocution.

### BRIEF DESCRIPTION OF DRAWINGS

Reference is now made to the accompanying drawings, in which common indexing and numerals are used for purpose of reference across all drawings, in which:

FIG. 1 is a 3D schematic depicting the front top-perspective view of the 1 rack unit version of the power distribution unit (for 120 VAC) constructed in accordance with principles of the present invention.

FIG. 2 is a 3D schematic depicting the front top-perspective view of the alternative 1.5 rack unit version of the power distribution unit (for 240 VAC) constructed in accordance with principles of the present invention.

FIGS. 3a, 3b and 3c are schematics depicting the plan view, front-side view and back-side view of the 1 rack unit version of the power distribution unit (for 120 VAC) constructed in accordance with principles of the present invention.

FIGS. 4a, 4b and 4c are schematics depicting the plan view, front-side view and back-side view of the alternate 1.5 rack unit version of the power distribution unit (for 240 VAC) constructed in accordance with principles of the present invention.

FIG. 5 is a wiring diagram for the first embodiment of the 1 rack unit version of the power distribution unit (for 120 VAC) constructed in accordance with principles of the present invention.

FIG. 6 is a wiring diagram for the first embodiment of the 1.5 rack unit version of the power distribution unit (for 240 VAC) constructed in accordance with principles of the present invention

Other details and features of the present invention will be apparent to the reader when the aforesaid drawings are considered in context of the detailed description to follow, as under.

### DETAILED DESCRIPTION OF THE PRESENT INVENTION

General purpose of the present invention is to solve most problems in existing art while incorporating all advantages of prior art and none of its disadvantages. Accordingly, the present invention is directed to the construction and operation of a PDU capable of providing reliable electrical power to a telecommunications facility, specifically where the individual feeds comprise diverse load requirements. Technical, ergonomic and commercial nuances, which will readily suggest from the description to follow, are intended to be covered by ambit of the present invention.

Referring generally to the drawings enclosed, the present inventor hereby proposes a PDU 000 that allows for up to six different sub-systems/loads to be protected and regulated. The PDU 000 proposed herein characteristically includes one main intelligent circuit breaker 001 and up to six subordinate individual hot-swap subordinate circuit breakers 002, 003, 004, 005, 006 and 007 with bullet type press-in contacts for individual load requirements. The preferred embodiment herein enlists a main 50 AMP circuit breaker and up to 6 individual 12 AMP circuit breakers for a first 120 VAC version, whereas a second 240 VAC version presently includes as many as up to 5 individual 15 AMP circuit breakers, of which each breaker has a hydraulic magnetic trip design and the main circuit breaker 001 has an additional integrated alarm functionality. It would be pertinent to note that the number of subordinate circuit breakers may be altered as per loads to be provided for in the application environment. The main circuit breaker incorporates an alarm contact notification in the event of an electrical feed outage or main breaker trip/fault notifying the user of an alarm event.

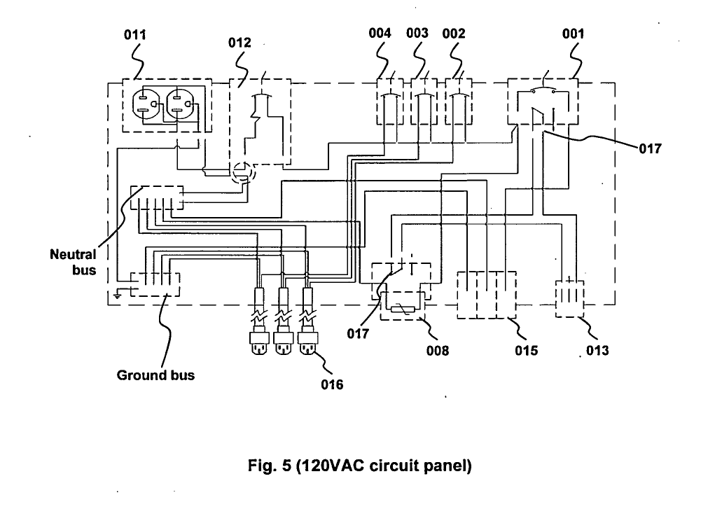

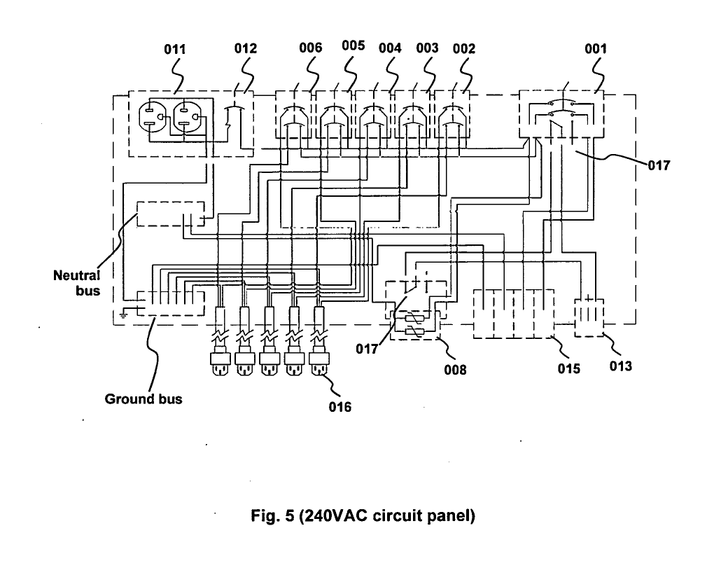

Referring to FIG. 5 and FIG. 6, it can be seen that simultaneous, yet safe and seamless distribution of electrical power to diverse loads is accomplished by routing the inbound electrical (utility/Anderson) power received at connector 015 having a protective cover 018 through the said main breaker 001 and lightning/surge suppression unit 008 and then through an internal bus bar (not shown in the accompanying drawings) which forms the electrical contact point for all of the individual hydraulic-magnetic circuit sub-breakers 001 to 006/007. Here, the individual sub-breakers also serve as circuit protection for each among the diverse loads. Diverse loads are further supported by selecting the appropriate sub-breaker size, from 12 amps to 2 amps (in the 120 VAC version of the PDU 000) or 2 amps to 15 amps (in the 240 VAC version of the PDU 000), protecting the user's specific equipment load requirements. By this construction, any individual load is ideally isolated from all other loads being powered by the PDU 000 which therefore allows the user to protect, service or maintain an individual circuit without effecting the other circuits, thereby keeping integrity of the system intact, and causing no system downtimes while such activities are being performed.

Besides routing inbound power to diverse loads, the power is also protected and regulated while being provided to multiple feeds having individual load requirements. Here, protection is provided through individual hydraulic-magnetic circuit breakers, while power fluctuations are regulated by the lightning/surge suppression unit 008 that is incorporated into the design and circuitry of the PDU 000 which protects against power transient impulses and over-voltage events, thereby resulting in a protected and regulated supply of electrical power. Monitored lightning-suppression layer and ground fault circuit protection functionality are thus integrated for protection of components from lightning strikes, utility power surge and anomalies and/or protection of human users from accidental electrocution. Accordingly, the PDU 000 incorporates internal grounding connected to external grounding and Ground Fault Circuit Interrupt (GFCI) which protects the user from electrical shock. (The PDU 000 has been approved and certified by UL so not to cause the operator any harm).

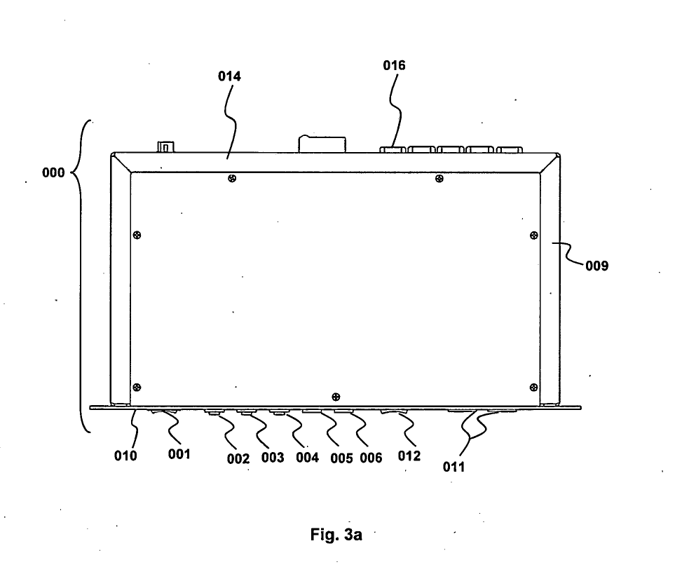

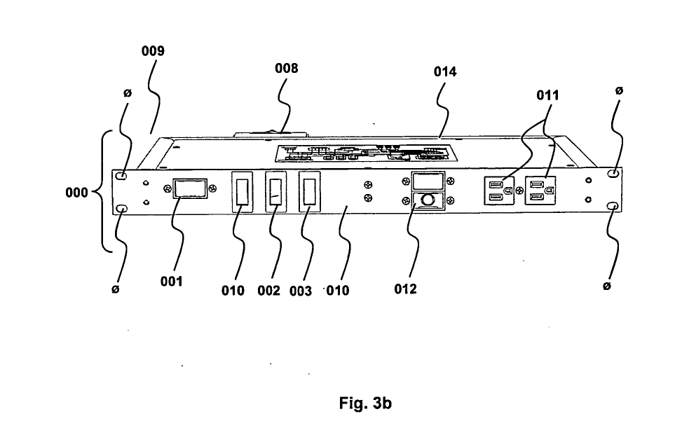

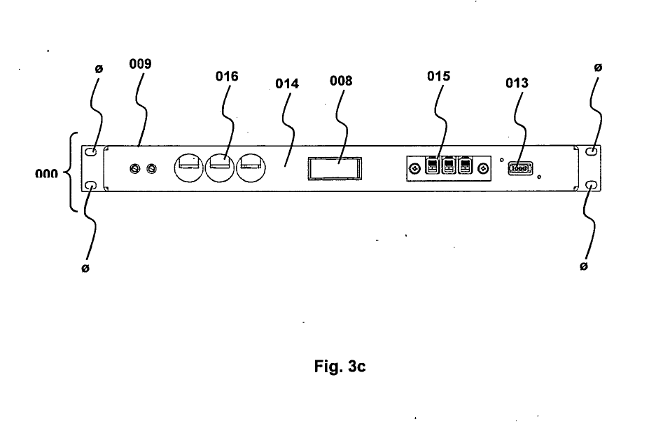

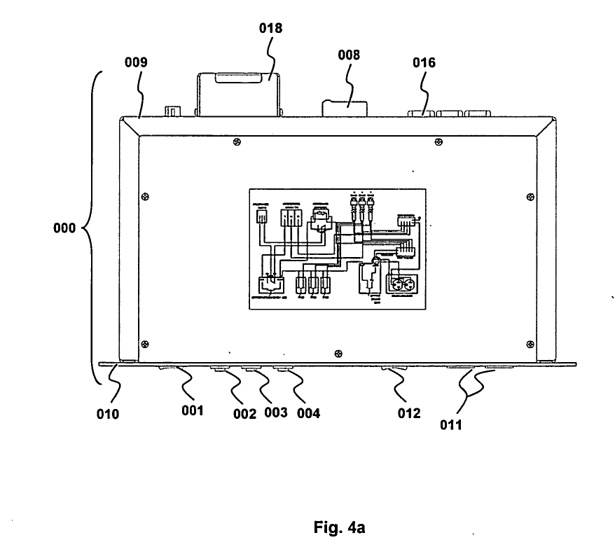

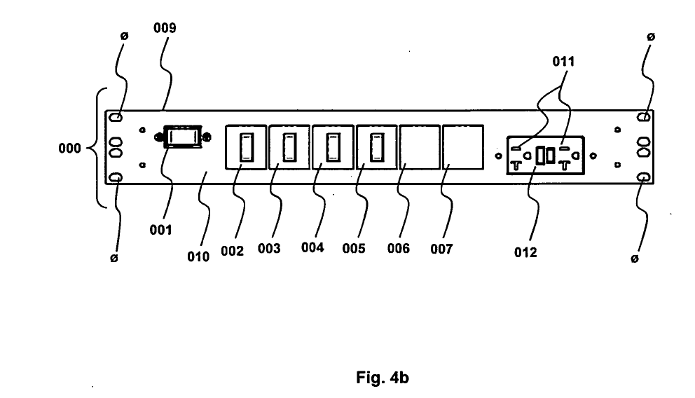

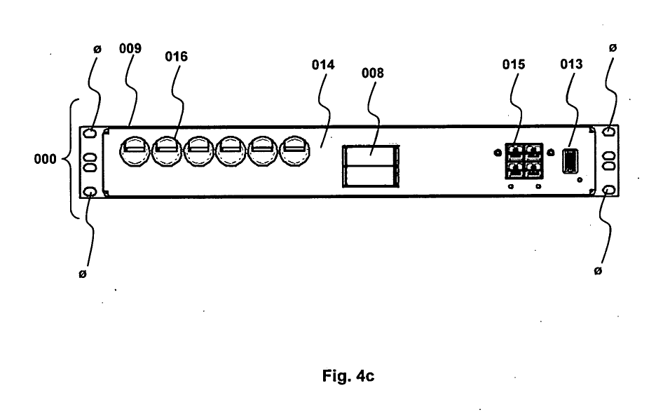

According to another aspect of the present invention and referring to constructional/assembly details reflected in FIGS. 3(a to c) and FIGS. 4(a to c), repair and maintenance of the PDU 000 on-site/on-field are made convenient by modular construction wherein the PDU frame skeleton 009 makes possible replacement of individual hot-swap sub breakers 002, 003, 004, 005, 006 and 007 with bullet type press-in contacts which can be replaced on-site/in field conditions. Accordingly, the front faceplate panel 010 of the PDU proposed supports up to 6 sub-breaker positions for the 120 VAC version of PDU 000 and up to 5 positions for the 240 VAC version of PDU 000 that can be serviced on-site/in the field. The snap-in breaker design protects the service technician from electrical shock while performing the service during normal operation. A lateral advantage of the manner of construction so employed is the ability to compartmentalize/localize component downtimes for repair or maintenance of the PDU 000 instead of otherwise/conventionally requiring a full system shutdown that would result in a system outage.

Additionally, the PDU 000 proposed herein is equipped with normally open/closed (NO/NC) dry contact 017 alarm outputs for both the main breaker 001 and lightning suppression system 008 which can be alarmed individually or as a single alarm point. Additionally, the lightning/surge protectors comprising 008 are replaceable modules with auto-reset facility that allows serviceability without disassembly of the PDU 000. Additionally, as seen from FIG. 5, protection from lightning strikes is provided by advantageous integration of an active frequency discrimination circuit (not shown in the accompanying drawings) which discriminates the difference between a temporary over-voltage condition and very fast lightning transient impulse to limit the incoming surge and thereby protecting the downstream electrical circuit and user loads. This allows the PDU 000 to keep operating and providing consistent transient protection before, during and after the transient event.

Another inventive feature of the present invention is the provision of a ground-fault circuit interrupter (GFI/GFCI) protected electrical convenience outlet 011 with resettable controller 012 to allow a technician to work closely with the electronics within the same cabinet as the PDU 000 and telecom equipment (not shown in the accompanying drawings) without plugging in to an electrical outlet elsewhere. This aspect ensures convenience of the technician who may require and otherwise benefit from access to electronic content relating to the equipment being serviced.

Attention of the reader is now directed to certain examples, which showcase how principles of the present invention are preferentially enabled/reduced to practice. To note, these examples are not limiting but merely illustrative as far as scope of the present invention is concerned.

### Example 1

### Controlled Dimensions

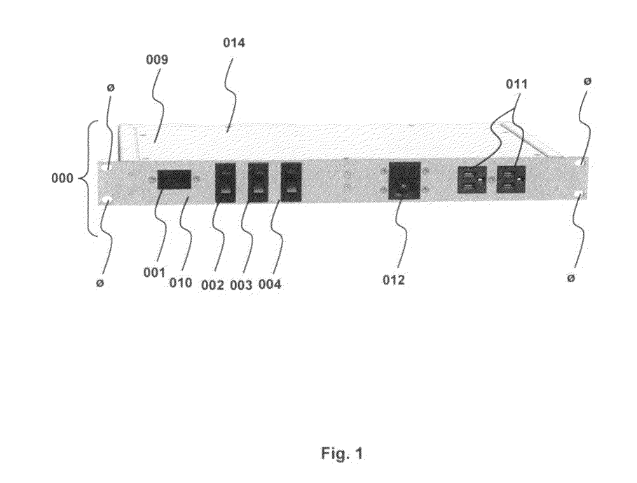

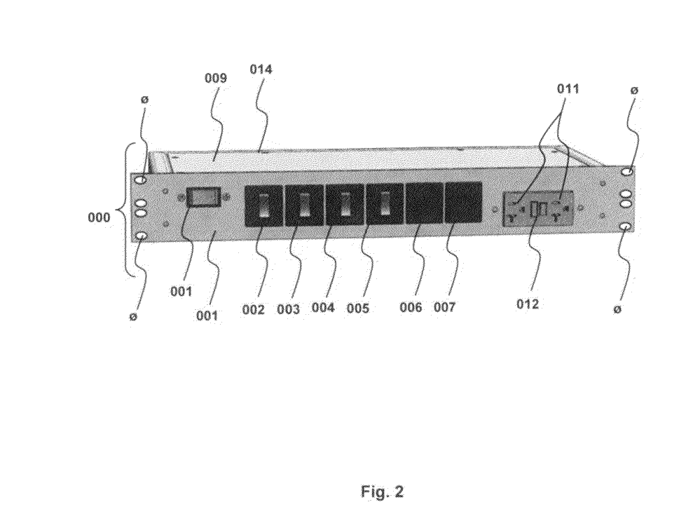

Reverting to the preferred embodiment referred herein, a rugged and reliable PDU is provided having shelf that is 1.75″ high, 10.3″ deep and mounts in 19-inch or 23-inch wide frames, thereby providing for a compact footprint that saves squarely on housing requirements but allowing high cost-performance ratio, stability and reliability. Generally referring to FIG. 1 and FIG. 2, two alternate embodiments of the PDU 000 are seen, which refer to the specifications among 1 RU (‘rack unit’, for 120 VAC version of the PDU 000) and 1.5 RU (for 240 VAC version of the PDU 000) respectively for convenient use and plug-and-play applicability in a rack mount environment allowing for a small footprint at any telecom site. The 1 RU (for 120 VAC) version of PDU proposed herein admeasures 19″×10.82″×1.72″ and weighs 6.57 kg whereas the 1.5 RU (for 240 VAC) version admeasures 19″×10.82″×2.59″ and weighs 7.16 kg, thereby implying compact dimensions and reduced footprint for manufacturing, storage, transport, as well as implementation. Shipping dimensions too, are greatly reduced with 24″×12″×3″ for the 1 RU (for 120 VAC) version whereas requiring 24″×12″×5″ for the 1.5 RU (for 240 VAC) version. The PDU 000 proposed herein, is designed to work preferably with a utility power source, or in the alternative, receive power from auxiliary sources including generator, UPS and battery sources without any change in performance of the present invention.

### Example 2

### Materials of Construction

Enclosures of the PDU 000 proposed herein are made from UL (that it, Underwriters Laboratories) certified standards and made from high strength aluminum (5052-H35 aluminum alloy or equivalent) and powder coated (DuPont-Alesta EP0301-9116927 or equivalent) to achieve a sturdy exterior, which serves for long-lasting durability of the PDU 000 under field conditions.

### Example 3

### Modular Assembly of Electronic Components

Circuit breakers (001 to 006/007), switches (not shown in the accompanying drawings), receptacles (not shown in the accompanying drawings), utility plugs 011, surge suppression unit 008, alarm notification connector 013, an optional snake light (not shown in the accompanying drawings) and other components of the PDU 000 proposed herein are adapted to be assembled in a modular manner. As seen in FIGS. 3(a to c) and FIGS. 4(a to c), front panel 010 and back panel 014 of the rectangular box-shaped enclosures are made to conform to a template based on electronic components to be assembled inside, output cabling (set of pigtail connectors 016 shown in FIG. 5) to be received on the back panel and user interface to be provided on the front panel for user access.

The PDU 000 is anchored to racks via nut-bolt, rivet or equivalent affixture via orifices “0” provided on laterally projecting lips/flanges of the front plate 010 and in the body of top or bottom panels (not shown in the accompanying drawings). These adaptations allow easy installation, serviceability and singular replacement of defective parts without necessarily removing the front, top or bottom panels or the entire PDU 000 from the rack to which it is associated as well as allowing progressively low-cost mass-manufacturing of the PDU 000 proposed herein.

Tolerances and thresholds of the PDU 000 proposed herein for protection of property and persons in the operational environment is advantageously provided in a separate module, which, in the embodiments defined herein, outline the respective specifications as set out in Table 1 below.

TABLE 1

| Version of PDU | 1 RU (for 120 VAC) | 1.5 RU (for 240 VAC) |
|---|---|---|
| Type of safety module | A | B |
| Nominal Voltage, Un | VAC 120-150 | VAC 220-240 |
| Max Cont. Operating | VAC 170 | VAC 275 |
| Voltage, Uc | | |
| Stand-off Voltage | 240 VAC | 440 VAC |
| Frequency | 0-100 Hz | |
| Short Circuit Current | 200 kAIC | |
| Rating, Isc 200 kAIC | | |
| Back-up Overcurrent | 125 AgL, if supply >100 A | |
| Protection | | |
| Technology | TD Technology with thermal disconnect | |
| Max Discharge Current, | 50 kA 8/20 μs | |
| Imax | | |
| Nominal Discharge | 25 kA 8/20 μs | 20 kA 8/20 μs |
| Current, In | | |
| Protection Modes Single | Single mode (L-G, L-N or N-G) | |
| mode (L-G, L-N or N-G) | | |
| Voltage Protection Level, | 400 V@ 3 kA 1.0 kV | 700 V @ 3 kA 1.2 kV 2 |
| Up | @ In | In |

| | |
|---|---|
| Status | N/O, N/C Change-over contact, 250 V~/0.5 A, |
| | max 1.5 mm² (#14 AWG) terminals Mechanical |
| | flag/remote contacts (R model only) |
| Dimensions H × D × W: | 90 × 68 × 18 (3.54 × 2.68 × 0.69) |
| mm (in) | |
| Module Width | 1 M |
| Weight: kg (lbs) | 0.12 (0.26) |
| Enclosure | DIN 43 880, UL94 V-0 thermoplastic, IP 20 |
| | (NEMA-1) |
| Connection ≦25 mm² | ≦25 mm² (#4 AWG) stranded ≦35 mm² |
| (#4 AWG) stranded | (#2 AWG) solid |
| Mounting | 35 mm top hat DIN rail |
| Temperature −40° C. to | −40° C. to 80° C. (−40° F. to 176° F.) |
| 80° C. (−40° F. to 176° F.) | |
| Humidity | 0% to 90% |
| Approvals | CE, IEC ® 61643-1, UL ® 1449 Ed.3 |
| | Recognized Component Type 2 |
| Surge Rated to Meet | ANSI ®/IEEE ® C62.41.2 Cat A, Cat B, Cat |
| | CANSI ®/IEEE ® C62.41.2 Scenario II, |
| | Exposure 2, 50 kA 8/20 μsIEC 61643-1 Class |
| | IIUL ® 1449 Ed. 3 In 20 kA mode |

### Example 4

### Input/Output and Safety Features

The PDU 000 proposed herein is designed to receive utility power or alternatively, backup power via a 3 screw isolated connector/modular plug 014 which is modularly integrated in the enclosure 009, which makes installation of the PDU 000 an easy process without necessarily requiring any tooling or opening the enclosure 009 for this purpose. In the embodiments recited herein, the input/regulated output are 120 VAC (for the 1 RU version) and 240 VAC (for the 1.5 RU version) respectively. Regulating power fluctuations is provided by the lightning/surge suppression unit 008 which protects against power transient impulses and over-voltage events, which is incorporated into the design and circuitry of the PDU 000. Protection from lightning strikes is provided by an active frequency discrimination circuit (not shown in the accompanying drawings) which discriminates the difference between a temporary over-voltage condition and a very fast lightning transient.

Additionally, the system 000 involves safety features in form of alarms for undesired events including power outages, power surges, and occurrence of ground fault, circuit breaker trip indication and lightning suppression. Here, the alarm monitoring and notification are an independent circuit which is designed to monitor the main circuit breaker 001 and the lightning/surge suppression unit 008. In the event the main breaker 001 trips or the lightning/surge suppression unit 008 becomes weak or faulty due to continued stressful operation, the alarm system monitoring circuit will provide a signal via NO/NC contact 017 closure notifying the user of the component trip or failure.

The alarm sensing circuit provides the operator/customer with the ability to continually monitor the PDU's performance and receive and alarm contact closure/open in the event of a utility power failure, main breaker trip or a lightning/surge suppressor trip or failure. The alarm sensing circuit customer connection port 013 is conveniently located at the back of the PDU enclosure 009 for easy connectivity. Further embodiments of the present invention are envisaged wherein the alarms are rendered tangible in form of single or combinations among visual signals (for example indicator lamps), audio signals (digital sounds or pre-recorded messages) or alerts notified to a remote supervisor via suitable relay or communication network.

The narration above thus provides for an enhanced PDU design intended for application in the telecommunications industry but also is fully adaptable for use in other environments such as data centers and critical data infrastructure.

Thus there has been presented a power distribution unit having comprehensive integrated features in the manner and form described hereinabove. It is understood that the list given above and phraseology and terminology used is for purpose of illustration and description. They are not intended to be exhaustive or to limit the present invention to precise form mentioned above and obviously many modifications and variations are possible in light of above elaborations without departing from spirit and scope of the present invention. Ambit of the present invention is restricted only by the appended claims.

I claim:

1. A power distribution unit for simultaneous supply of protected and regulated electrical power to diverse loads, said power distribution unit comprising an enclosure of compact proportions and diminutive footprint characteristically adapted to modularly receive components of the power distribution unit, including:
an isolated individually-removable connector module with protective cover for receiving inbound electrical power from an utility source or in the alternative, from auxiliary sources including generator, UPS and battery sources;
A main circuit breaker switch for controlling the inbound electrical power received by the power distribution unit;
An lightning and surge suppression unit for first receiving the inbound electrical power and regulating fluctuations in the same;
A common internal bus bar for receiving the regulated and conditioned inbound electrical power from the lightning and surge suppression unit;
A plurality of subordinate circuit breakers in electrically conductive association with the common internal bus bar for protection and simultaneous distribution of regulated and conditioned inbound electrical power to diverse loads;
A plurality of isolated output connectors for receiving power cables from loads connected to the power distribution unit and at least one resettable ground-fault circuit interrupter protected electrical convenience outlet on the power distribution unit for providing utility electrical power to an external user device; and
at least one alarm system capable of issuing an alert in the event of utility power failure, main breaker trip, lightning and surge suppressor trip and failure or deviation of electrical power supply as required for the desired diverse electrical loads.

2. The power distribution unit of claim 1, wherein the diminutive proportions are 19″×10.82″×1.72″ for the 1 rack unit power distribution unit configured to provide 120 VAC electric power.

3. The power distribution unit of claim 1, wherein the diminutive proportions are 19″×10.82″×2.59″ for the 1.5 rack unit power distribution unit configured to provide 240 VAC electric power.

4. The power distribution unit of claim 1, wherein the enclosure is rectangular in shape and further characterized in being adapted to mount on racks of telecommunication equipment cabinets via orifices in the laterally projecting lips/flanges of the front, top and bottom panels of the enclosure which are anchored to the cabinet racks via affixing means chosen among nut-bolt, rivet and their equivalents.

5. The power distribution unit of claim 4, in which modularly received components included in the power distribution unit are each individually removable for easy installation, serviceability and independent replacement when defective without necessarily removing the front, top or bottom panels or the entire PDU from the rack for such purpose.

6. The power distribution unit of claim 1, wherein the circuit breakers are of the individual hot-swap variety having bullet type press-in contacts and include a main circuit breaker and a plurality of subordinate circuit breakers the individual serviceability and replaceability of which help to significantly reduce the efforts as well as operations and maintenance costs thereby reducing the overall cost of electricity in the application environment.

7. The power distribution unit of claim 6, including a 50 AMP main circuit breaker and up to six 12 AMP subordinate circuit breakers for resulting in a 120 VAC, 1 rack unit power distribution unit.

8. The power distribution unit of claim 6, including a 60 AMP main circuit breaker and up to five 15 AMP subordinate circuit breakers for resulting in a 240 VAC, 1.5 rack unit power distribution unit.

9. The power distribution unit of claim 1, wherein the alarm system is an alarm sensing circuit which continually monitors performance of the power distribution unit which is configured for actuation upon occurrence of an event selected among utility power failure, main breaker trip or a lightning-and-surge suppressor trip and failure of components involved in the power distribution unit.

10. The power distribution unit of claim 9, wherein the alarm sensing circuit is connected to an alarm sensing circuit customer connection port on back panel of the power distribution unit for relay of alerts to the user using a communications network.

11. The power distribution unit of claim 9, wherein the alarm system equipped with NO/NC dry contact alarm outputs for both the main breaker and lightning suppression system which can optionally be alarmed either individually or as a single alarm point.

12. The power distribution unit of claim 1, wherein the lightning and surge suppression unit further comprises an active frequency discrimination circuit capable of discerning between a temporary over-voltage condition and very fast lightning transient impulse thereby providing protection to the user's expensive electronic equipment and avoiding consequential loss of revenue due to business disruption and unscheduled system downtime.

13. The power distribution unit of claim 1, wherein the lightning and surge suppression unit is modularly integrated in said power distribution unit itself thereby eliminating the necessity of providing external bulky suppression units.

14. The power distribution unit of claim 1, which incorporates monitored lightning-suppression layer and ground fault circuit protection functionality for protection of components of the power distribution unit from lightning strikes, utility power surge and anomalies and protection of human users from accidental electrocution.

15. The power distribution unit of claim 1, in which the subordinate circuit breakers are selected in the range between 02 AMP to 12 AMP for the 120 VAC configuration of the PDU in accordance with individual input power specifications of the diverse loads connected to said power distribution unit.

16. The power distribution unit of claim 1, in which the subordinate circuit breakers are selected in the range between 02 AMP to 15 AMP for the 240 VAC configuration of the PDU in accordance with individual input power specifications of the diverse loads connected to said power distribution unit.

17. The power distribution unit of claim 1, wherein the modularity of operable assemblage helps to compartmentalize component downtimes for repair or maintenance of the power distribution unit
